(19) United States
(12) Patent Application Publication
(10) Pub. No.: US 2007/0060066 A1
(43) Pub. Date: Mar. 15, 2007

(54) System and method for preventing performance degradation in communication circuitry

(75) Inventor: Vishnu Srinivasan, Austin, TX (US)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(73) Assignee: Silicon Laboratories

(21) Appl. No.: 11/226,837

(22) Filed: Sep. 14, 2005

(51) Int. Cl. H04Q 7/32

(52) U.S. Cl. 455/67.11

(57) ABSTRACT

A system comprising first interface circuitry that includes a first input pad of first receiver circuitry, and control circuitry configured to operate the first interface circuitry in a first mode to prevent the first receiver circuitry from receiving a first signal using the first input pad and a second mode to allow the first receiver circuitry to receive a second signal using the first input pad is provided.

### BACKGROUND

Communication systems typically include a transmitter and a receiver configured to transmit and receive signals, respectively. By transmitting and receiving signals, communication systems operate to exchange information with other communication systems. As communications systems decrease in physical size, system components may be spaced in increasingly close proximity to one another. The close proximity of system components may increase the likelihood that the operation one component in the system may adversely affect the operation of another component in the system. The likelihood of adverse affects may be further increased when components operate in the same or overlapping frequency ranges.

For example, a receiver front-end may not sufficiently attenuate a signal transmitted by a transmitter in a communication system, particularly where the frequency range of the receiver front-end includes the frequency of the transmitted signal. As a result, the signal may transmit into the receiver and damage or stress the receive circuitry because of the high power levels of the signal. In addition, during transmission, the signal that couples into the receiver may create interference that causes performance degradation in the transmitter or in other components of the communication system. It would be desirable to minimize damage and performance degradation caused by transmitting signals in a communications system.

### SUMMARY

According to one exemplary embodiment, a system comprising first interface circuitry that includes a first input pad of first receiver circuitry, and control circuitry configured to operate the first interface circuitry in a first mode to prevent the first receiver circuitry from receiving a first signal using the first input pad and a second mode to allow the first receiver circuitry to receive a second signal using the first input pad is provided.

According to another exemplary embodiment, a method performed by a system that includes receiver circuitry is provided. The method comprises operating interface circuitry in a first mode to prevent the receiver circuitry from receiving a first signal using the input pad, and operating the interface circuitry in a second mode to allow the receiver circuitry to receive a second signal using the input pad.

According to a further exemplary embodiment, a communications device comprising an antenna, a mobile communications system configured to communicate with a remote host using the antenna and including receiver circuitry with interface circuitry that includes an input pad, transmitter circuitry, and control circuitry, and an input/output system configured to communicate with the mobile communications system is provided. The transmitter circuitry is configured to transmit a first signal using the antenna and the control circuitry is configured to operate the interface circuitry in a first mode to prevent the receiver circuitry from receiving the first signal using the input pad and a second mode to allow the receiver circuitry to receive a second signal from the remote host using the input pad.

According to another exemplary embodiment, a system comprising means for preventing receiver circuitry from receiving a first signal using an input pad during a first time slot, and means for allowing the receiver circuitry to receive a second signal using the input pad during a second time slot that is subsequent to the first time slot is provided.

### BRIEF DESCRIPTION OF THE DRAWINGS

FIG. 1 is a block diagram illustrating one embodiment of a mobile communication system.

FIG. 2 is a block diagram illustrating another embodiment of a mobile communication system.

FIG. 3 is a block diagram illustrating one embodiment of an interface unit.

FIG. 4 is a schematic diagram illustrating one embodiment of an interface unit.

FIG. 5 is a graph illustrating one embodiment of operating a mobile communication system.

FIG. 6 is a block diagram illustrating one embodiment of a mobile device that includes the mobile communication system shown in FIG. 1.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

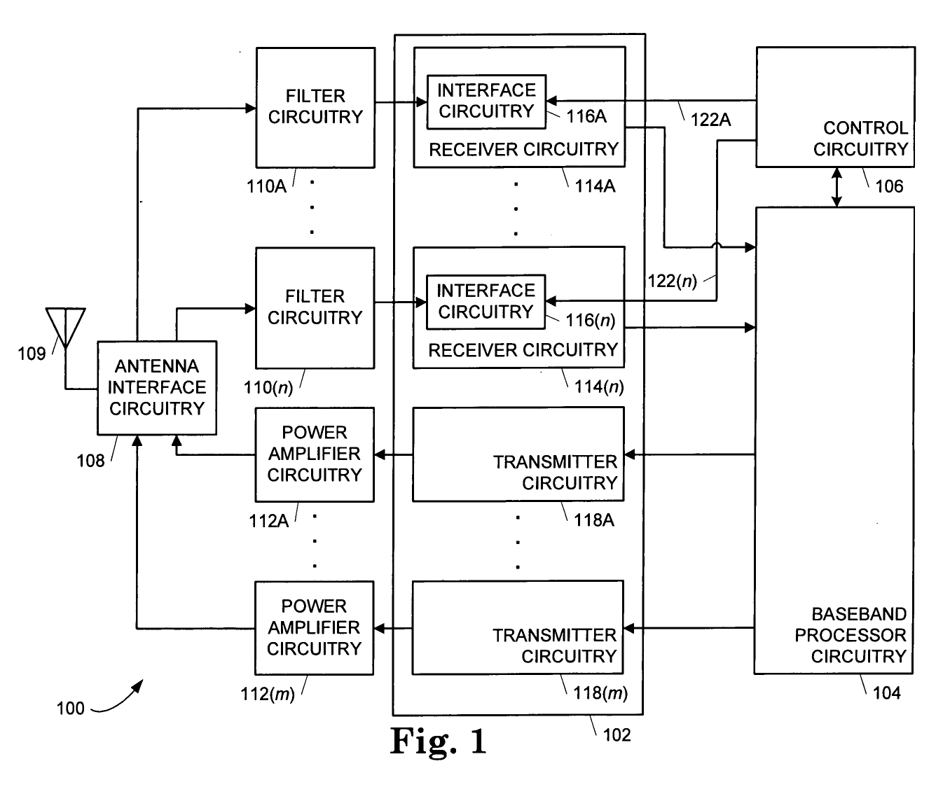

As described herein, a mobile communication system that includes communication circuitry, such as radio-frequency (RF) circuitry, and processing circuitry is provided as shown in the embodiments of FIGS. 1-6. The RF circuitry includes receiver circuitry and transmitter circuitry. During time periods where receiver circuitry in the mobile communication system is not active, the system is configured to operate interface circuitry in the receiver circuitry to prevent electrical interference from affecting other circuitry in the system such as the transmitter circuitry. For example, the system may cause input pads of the interface circuitry to be shorted to ground during time periods where the receiver circuitry is not active. By doing so, the system may prevent RF signals from the transmitter circuitry or interference from other circuitry in the system from causing performance degradation in the transmitter, or in other components of the system. In addition, the system may prevent the relatively strong RF signals from the transmitter circuitry from damaging the sensitive elements of the receiver circuitry or other components of the system.

FIG. 1 is a block diagram illustrating one embodiment of a mobile communications system 100. System 100 includes radio-frequency (RF) circuitry 102, baseband processor circuitry 104, control circuitry 106, antenna interface circuitry 108, an antenna 109, one or more instances of filter circuitry 110, and one or more instances of power amplifier circuitry 112.

RF circuitry 102 is configured to transmit and receive information using antenna 109. Antenna 109 is coupled, directly or indirectly, to antenna interface circuitry 108. The information may comprise voice or data communications, for example.

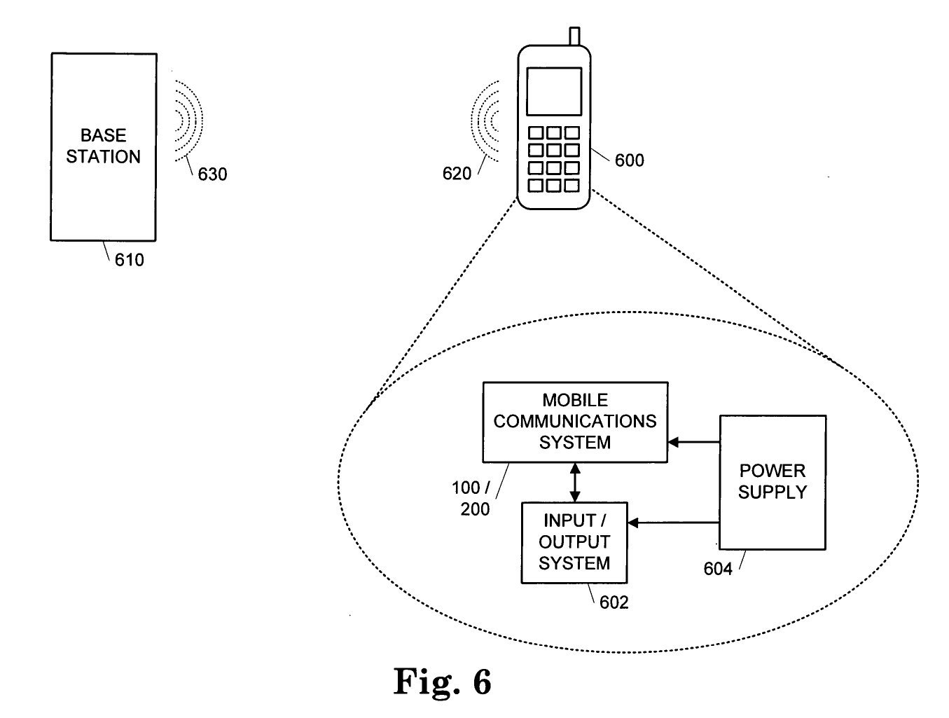

RF circuitry 102 includes one or more instances of receiver circuitry 114A through 114(n) configured to receive information from respective instances of filter circuitry 110A through 110(n) where n is greater than or equal to one and represents the nth instance of receiver circuitry 114 and filter circuitry 110. To receive information, an instance of receiver circuitry 114 receives an RF signal that includes information from a remote transmitter (e.g., a base station 610 as shown in FIG. 6) through antenna 109, antenna interface circuitry 108, and corresponding filter circuitry 110. Receiver circuitry 114 provides the information to baseband processor circuitry 104 for processing.

In one embodiment, respective instances of receiver circuitry 114 and filter circuitry 110 are configured to receive information from a selected frequency band, e.g., a GSM 850, a EGSM, a PCS, or a DCS band. In this embodiment, each instance of filter circuitry 110 is configured to filter an RF signal from a selected frequency band and provide the filtered RF signal to a respective instance of receiver circuitry 114. Each instance of receiver circuitry 114 amplifies a filtered RF signal from a respective instance of filter circuitry 110, converts the amplified RF signal to digital information, and provides the digital information to baseband processor circuitry 114.

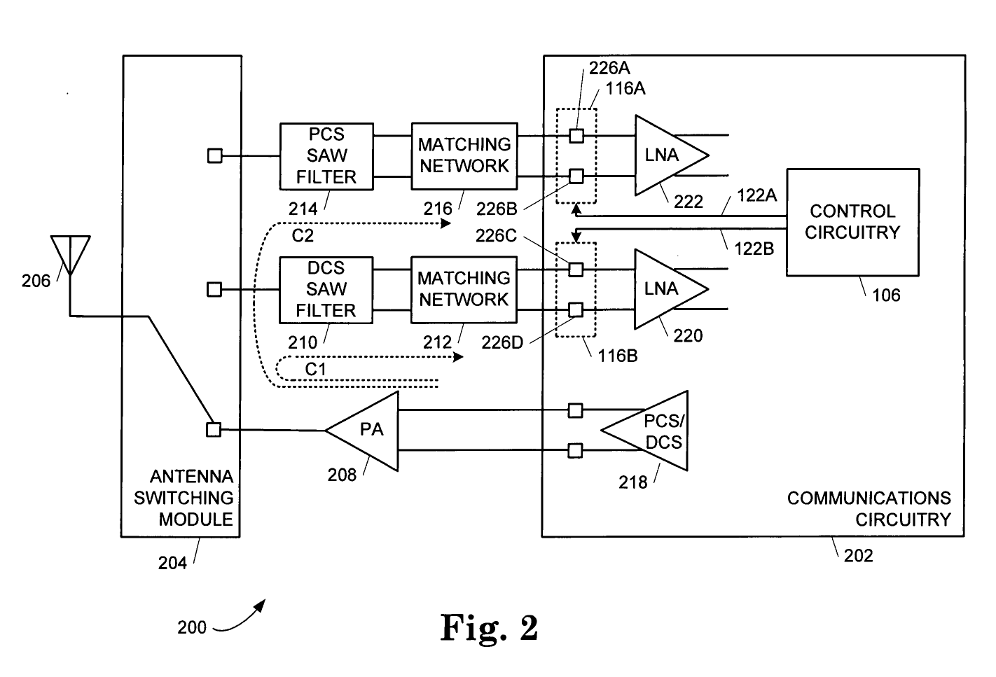

In one embodiment, each instance of filter circuitry 110 includes a surface-acoustic-wave (SAW) filter (e.g., DCS SAW filter 210 or PCS SAW filter shown in the embodiment of FIG. 2) configured to filter the RF signal in a frequency band of a corresponding instance of receiver circuitry 114 and a matching network (e.g., matching network 212 or matching network 216 shown in the embodiment of FIG. 2). Filter circuitry 110 receives RF signals in a frequency band (e.g., a GSM 850, a EGSM, a PCS, or a DCS band), filters the RF signals using the SAW filter, passes the filtered RF signal through the matching network, and provides the filtered PCS RF signals to receiver circuitry 114.

In one embodiment, each instance of receiver circuitry 114 amplifies the filtered RF signal, down-converts the amplified RF signal, amplifies the down-converted signal, converts the amplified down-converted signal to digital information, and provides the digital information to baseband processor circuitry 104.

RF circuitry 102 also includes one or more instances of transmitter circuitry 118A through 118(m) configured to provide information to respective instances of power amplifier circuitry 112A through 112(m) where m is greater than or equal to one and represents the mth instance of transmitter circuitry 118 and power amplifier circuitry 112. To transmit information, an instance of transmitter circuitry 118 receives information to be transmitted from baseband processor circuitry 104, generates an RF signal that includes the information, and provides the RF signal to power amplifier circuitry 112. Power amplifier circuitry 112 amplifies the RF signal and provides the amplified RF signal to antenna interface circuitry 108 for transmission by antenna 109.

In one embodiment, respective instances of transmitter circuitry 118 and power amplifier circuitry 112 are configured to transmit information using a selected frequency band, e.g., a GSM 850, a EGSM, a PCS, or a DCS band. In this embodiment, each instance of transmitter circuitry 118 is configured to generate an RF signal using a selected frequency band and provide the RF signal to a respective instance of power amplifier circuitry 112. Each instance of power amplifier circuitry 112 amplifies the RF signal in the selected frequency band and provides the amplified RF signal to antenna interface circuitry 108 for transmission by antenna 109.

Baseband processor circuitry 104 is configured to perform digital baseband processing, e.g., voice and/or data processing, on information to be transmitted by RF circuitry 102 and on information received by RF circuitry 102. Baseband processor circuitry 104 may also be configured to perform digital processing on other information that is not associated with RF circuitry 102, i.e., information that is not to be transmitted by or has not been received from RF circuitry 102.

Control circuitry 106 is configured to control the operation of the components of mobile communications system 100 including RF circuitry 102 and baseband processor circuitry 104. For example, control circuitry 106 is configured to activate and deactivate sections of baseband processor circuitry 104. Control circuitry 106 is also configured to activate and deactivate sections of RF circuitry 102 according to the mode of operation. Control circuitry 106 includes any suitable combination of hardware and/or software components to perform the functions described herein.

Control circuitry 106 is configured to provide a signal 122 to each instance of interface circuitry 116 to independently control the operation of each instance of interface circuitry 116 in at least two modes of operation, e.g., a receive mode and a transmit mode.

Interface circuitry 116 is configured to operate in at least two modes as determined by signal 122 from control circuitry 106. In a first mode of operation, e.g., the transmit mode of operation, interface circuitry 116 is configured to prevent any signals, including electrical interference, from being received by receiver circuitry 114 using the input pads. In a second mode of operation, e.g., the receive mode of operation, interface circuitry 116 is configured to provide filtered RF signals from filter circuitry 110 to receiver circuitry 114 using input pads (shown in FIGS. 2, 3, and 4) in interface circuitry 116. In this mode, interface circuitry 116 also configured as an ESD structure to provide ESD protection to receiver circuitry 114.

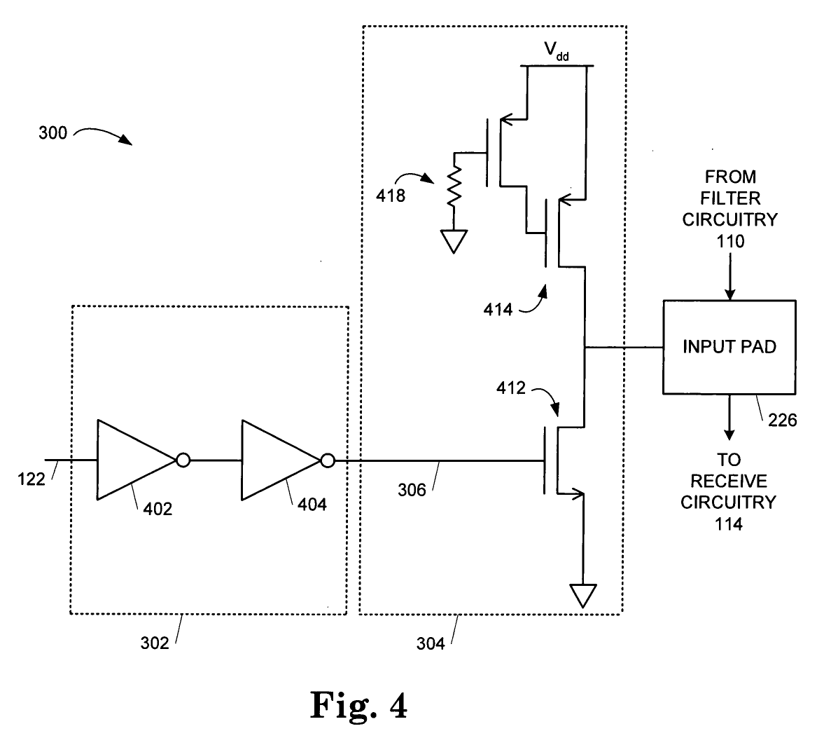

In one embodiment described with reference to FIG. 4 below, interface circuitry 116 is configured to short each input pad to ground. In other embodiments, interface circuitry 116 is configured to short each input pad to a voltage source (not shown). In further embodiments, interface circuitry 116 is configured to short each input pad to one or more other input pads using a shorting switch (not shown). For example, interface circuitry 116 may be configured to short each pair of differential input pads together using a shorting switch for each pair. The shorting switches may, however, cause performance degradation in receiver circuitry 114. In the second mode of operation, interface circuitry 116 prevents electrical interference, such as interference generated by one or more instances of transmitter circuitry 118, from causing damage to receiver circuitry 114 and also, adversely affecting the operation of transmitter circuitry 118 or other circuitry in system 100.

In operation, one or more instances of receiver circuitry 114 and corresponding filter circuitry 110 may be configured to operate in a frequency band that overlaps a frequency band of one or more instances of transmitter circuitry 118. As a result, a portion of the RF signals transmitted by transmitter circuitry 118 may pass through antenna interface circuitry 108, filter circuitry 110, and interface circuitry 116 into receiver circuitry 114. The portion of the RF signals that are received by receiver circuitry 114 may cause damage or other unintended effects on circuitry, such as low noise amplifier (LNA) circuitry, in receiver circuitry 114. In addition, the portion of the RF signals (phase-shifted and/or attenuated transmit or other signals) that are received by receiver circuitry 114 may couple into the substrate, bias circuitry, other receiver circuitry, or even transmit related circuitry resulting in performance degradation. To prevent damage or other unintended effects in system 100, interface circuitry 116 is configured to operate in at least the two modes noted above as described in additional detail with reference to FIGS. 2-5 below.

Control circuitry 106 may be configured to selectively control the operation of each instance of interface circuitry 116 in the two modes of operation. For example, control circuitry 106 may cause each instance of interface circuitry 116 to operate in the transmit mode any time that an instance of receiver circuitry 114 is not in use, e.g., in a transmit or a signal processing time slot as described in additional detail below. Control circuitry 106 may also cause fewer than all instances of interface circuitry 116 to operate in the transmit mode any various times or in various time slots. Control circuitry 106 may be further configured to selectively control the operation of each instance of interface circuitry 116 according to other conditions or according to operations of other components of mobile communications system 100.

In one embodiment, mobile communication system 100 includes a time-division-multiplexed (TDM) communication system such as a time-division multiple access (TDMA) system, a GSM system, a GPRS system, or an EDGE system. In addition, RF circuitry 102 operates according to one or more communication protocols, channels, and frequency bands (e.g., GSM 850, EGSM, PCS, and DCS). In other embodiments, mobile communication system 100 includes another type of multi-band, multi-mode communication system such as a Bluetooth, a WLAN, a WCDMA, or a CDMA2000 communication system.

FIG. 2 is a block diagram illustrating an embodiment of a mobile communication system 200. Mobile communication system 200 includes communications circuitry 202, an antenna switching module 204, an antenna 206, a power amplifier 208, a DCS SAW filter 210, a matching network 212, a PCS SAW filter 214, and a matching network 216. Communications circuitry 202 includes a PCS/DCS transmitter buffer 218, interface circuitry 116A and 116B, control circuitry 106, and LNAs 220 and 222. Interface circuitry 116A includes input pads 226A and 226B connected to matching network 216, and interface circuitry 116B includes input pads 226C and 226D connected to matching network 212. Input pads 226A and 226B are connected as a differential input to LNA 222, and input pads 226C and 226D are connected as a differential input to LNA 220.

In the embodiment of FIG. 2, transmitter buffer 218 and power amplifier 208 comprise a portion of transmitter circuitry that is configured to transmit information in either the DCS frequency band or the PCS frequency band. DCS SAW filter 210, matching network 212, and LNA 220 comprise a portion of receiver circuitry that is configured to receive information from the DCS frequency band. PCS SAW filter 214, matching network 216, and LNA 222 comprise a portion of receiver circuitry that is configured to receive information from the PCS frequency band. In other embodiments, transmitter buffer 218 may be configured to transmit information in one of the PCS and DCS frequency bands and another transmitter buffer (not shown) may be included to transmit information in the other frequency band.

In other embodiments, the transmitter circuitry may transmit information in other frequency bands such as GSM 850 or EGSM and the receiver circuitry may receive information in other frequency bands such as GSM 850 or EGSM.

Communications circuitry 202 is configured to transmit and receive information using antenna 206. Antenna 206 is coupled, directly or indirectly, to antenna switching module 204. The information may comprise voice or data communications, for example.

To transmit information, system 200 causes antenna switching module 204 to connect antenna 206 to power amplifier 208 to allow antenna 206 to transmit information provided by transmitter buffer 218 and amplified by power amplifier 208. Communication circuitry 202 is configured to receive the information to be transmitted from processing circuitry (not shown) and provide the information to transmitter buffer 218.

To receive information, system 200 causes antenna switching module 204 to connect antenna 206 to DCS SAW filter 210 or PCS SAW filter 214. If antenna 206 is connected to DCS SAW filter 210, received information is filtered by DCS SAW filter 210, passed through matching network 212, received across interface 116B, and amplified by LNA 220 for processing by communications circuitry 202. If antenna 206 is connected to PCS SAW filter 214, received information is filtered by PCS SAW filter 214, passed through matching network 216, received across interface 116A, and amplified by LNA 222 for processing by communications circuitry 202. Communication circuitry 202 is configured to down-convert amplified signals from LNAs 220 and 222, amplify the down-converted signal, convert the amplified down-converted signal to digital information, and provides the digital information to processing circuitry (not shown).

Control circuitry 106 is configured to provide signal 122A to interface circuitry 116A and signal 122B to interface circuitry 116B to control the operation of interface circuitry 116A and 116B, respectively, in at least two modes of operation, e.g., a receive mode and an transmit mode, as described above with reference to FIG. 1.

In operation, antenna switching module 204 electrically isolates receiver circuitry during transmission of information by transmitter circuitry by selectively connecting receiver circuitry or transmitter circuitry to antenna 206. In one embodiment, antenna switching module 204 may provide approximately 20 dB of isolation from the transmitted signal to the antenna leaking back to the receive circuitry. This is illustrated as the part of the path C1 and C2 between the power amplifier 208 and the DCS SAW filter 210 and PCS SAW filter 214 respectively. This coupling mechanism inside the antenna switching module 204 is typically capacitive. In addition, DCS SAW filter 210 and PCS SAW filter 214 provide approximately 30-50 dB of isolation outside their respective frequency bands of operation, i.e., outside of the DCS and PCS frequency bands, respectively.

In the GSM/GPRS/EDGE mobile communication system, the PCS (mobile-station) transmit frequency band is 1850 MHz to 1910 MHz, and the receive frequency band is 1930 MHz to 1990 MHz. Likewise, the DCS (mobile-station) transmit frequency band is 1710 MHz to 1785 MHz, and the receive frequency band is 1805 MHz to 1880 MHz. Note that part of the PCS transmit frequency band overlaps with part of the DCS receive frequency band.

When the frequency band of a signal transmitted by transmitter circuitry does not overlap with the frequency band of receiver circuitry in system 200, system 200 sufficiently attenuates the signal to prevent adverse affects such as damage from high voltage stress or performance degradation from occurring. For example along coupling path C2, when transmitter buffer 218 and power amplifier 208 transmit +34 dBm signal in the PCS frequency band, antenna switching module 204 attenuates the signal by approximately 20 dBm to leave a +14 dBm signal. PCS SAW filter 214 further attenuates the +14 dBm signal by approximately 40 dBm, for example, to leave a signal of −26 dBm that reaches matching network 216 and LNA 222. In the embodiment of FIG. 2, the −26 dBm signal is unlikely to cause adverse affects on communication circuitry 202.

When the frequency band of a signal transmitted by transmitter circuitry does overlap with the frequency band of receiver circuitry in system 200, however, system 200 may not sufficiently attenuate the signal to prevent adverse affects such as damage from high voltage stress or performance degradation from occurring. For example along coupling path C1, when transmitter buffer 218 and power amplifier 208 transmit +34 dBm signal in the PCS frequency band, antenna switching module 204 attenuates the signal by approximately 20 dBm to leave a +14 dBm signal. Because the DCS frequency band of DCS SAW filter 210 overlaps with the transmitted signal in the PCS frequency band, DCS SAW filter 210 may not significantly attenuate the +14 dBm signal. As a result, the +14 dBm signal may reach matching network 212 and LNA 220. In the embodiment of FIG. 2, the +14 dBm signal may cause a high voltage across the differential input of LNA 220 that may damage LNA 220. In addition, the +14 dBm signal may couple directly, capacitively, or magnetically to the substrate or other circuitry, e.g., transmitter, receiver, or bias circuitry, causing performance degradation in that circuitry.

In the embodiment of FIG. 2, the PCS transmit frequency band and the DCS receive frequency bands are one example of frequency bands that overlap. In other embodiments, other receiver and transmitter circuitry may operate using other frequency bands that overlap.

To prevent damage and performance degradation of communications circuitry 202, interface circuitry 116A and 116B are each configured to operate in at least two modes as determined by signals 122A and 122B, respectively, from control circuitry 106.

In a receive mode of operation, interface circuitry 116A is configured to allow signals from matching network 216 to be provided to LNA 222 across input pads 226A and 226B. Similarly, interface circuitry 116B is configured to allow signals from matching network 212 to be provided to LNA 220 across input pads 226C and 226D. In the embodiment of FIG. 2, control circuitry 106 activates the receive mode to allow signals to be received by receiver circuitry coupled to antenna 206 by antenna switching module 204, e.g., the receiver circuitry that includes DCS SAW filter 210 or PCS SAW filter 214. In the receive mode, interface circuitry 116A and 116B are also configured as ESD structures to provide ESD protection to communications circuitry 202.

In an transmit mode of operation, interface circuitry 116A is configured to prevent signals from matching network 216 from being provided to LNA 222 across input pads 226A and 226B, e.g., signals from coupling path C2. Similarly, interface circuitry 116B is configured to prevent signals from matching network 212 from being provided to LNA 220 across input pads 226C and 226D, e.g., signals from coupling path C1. In one embodiment described with reference to FIG. 4 below, interface circuitry 116A and 116B are configured to short each input pad 226 to ground. In other embodiments, interface circuitry 116A and 116B are configured to short each input pad 226 to a voltage source (not shown). In further embodiments, interface circuitry 116A is configured to short input pad 226A to input pad 226B using a shorting switch (not shown), and interface circuitry 116B is configured to short input pad 226C to input pad 226D using a shorting switch (not shown). If additional shorting switches are used for this purpose, they may, however, cause performance degradation of LNAs 220 and 222, respectively.

In the transmit mode of operation, interface circuitry 116A and 116B prevent signals transmitted by power amplifier 208 from damaging LNAs 220 or 222, respectively, or degrading the performance of communications circuitry 202.

Control circuitry 106 is configured to selectively control the operation of interface circuitry 116A and 116B in the two modes of operation. For example, control circuitry 106 may cause interface circuitry 116A to operate in the transmit mode any time that PCS SAW filter 214 is not connected to antenna 206 by antenna switching module 204, and control circuitry 106 may cause interface circuitry 116B to operate in the transmit mode any time that DCS SAW filter 210 is not connected to antenna 206 by antenna switching module 204.

In the embodiment of FIG. 2, mobile communication system 200 includes a time-division-multiplexed (TDM) communication system such as a time-division multiple access (TDMA) system, a GSM system, a GPRS system, or an EDGE system. In other embodiments, mobile communication system 200 includes another type of multi-band, multi-mode communication system such as a Bluetooth, a WLAN, a WCDMA, or a CDMA2000 communication system.

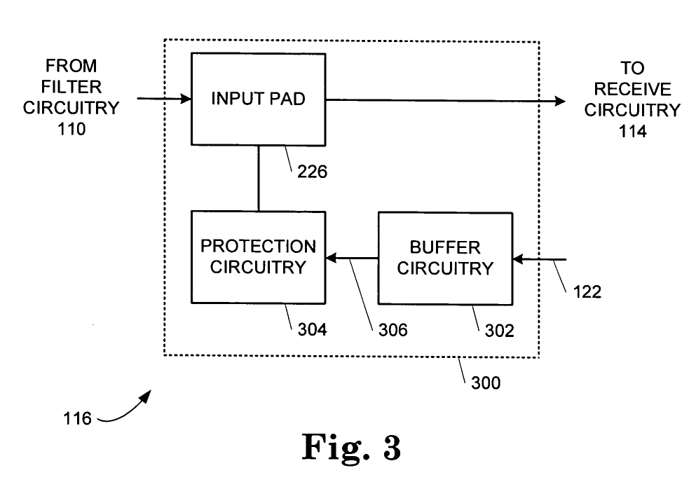

FIG. 3 is a block diagram illustrating one embodiment of one instance of an interface unit 300 in interface circuitry 116. Interface unit 300 includes buffer circuitry 302, protection circuitry 304, and input pad 226. Interface circuitry 116 includes any number of instances of interface unit 300. In one embodiment, interface circuitry 116 includes one instance of interface unit 300 for each input pad 226 of receiver circuitry 114. In other embodiments, interface circuitry 116 includes one instance of interface unit 300 for selected input pads 306 of receiver circuitry 114.

Buffer circuitry 302 receives an instance of signal 122 from control circuitry 106 (shown in FIG. 1) and provides a buffered signal 306 to protection circuitry 304. Buffer circuitry 302 is configured to provide electrical isolation between input pad 226 and other input pads relative to control circuitry 106, filter circuitry 110, and receiver circuitry 114 to allow a single signal 122 to operate numerous instances of protection circuitry 304. Accordingly, buffer circuitry 302 prevents interference from other circuitry in control circuitry 106, other filter circuitry 110, and other receiver circuitry 114 from affecting the operation of input pad 226.

Protection circuitry 304 receives buffered signal 306 from buffer circuitry 302 and causes one of two states of input pad 226 in response to a logic level of buffered signal 306. In one embodiment, protection circuitry 304 is also configured to provide electrostatic discharge (ESD) protection to receiver circuitry 114. To do so, protection circuitry 304 includes circuitry configured to prevent relatively large voltages or currents, e.g., from the discharge of static electricity, from causing damage to receiver circuitry 114.

Input pad 226 includes an electrically conductive structure (not shown) that is electrically connected to filter circuitry 110, receiver circuitry 114, and protection circuitry 304. In embodiments where receiver circuitry 114 is contained in a housing (not shown) such as an integrated circuit package, the electrically conductive structure may be constructed such that at least a portion of the structure is exposed outside of the housing to allow external circuitry, such as filter circuitry 110, to be electrically connected to the portion of the structure.

In operation, protection circuitry 304 is configured to operate input pad 226 in a first mode, i.e., an transmit mode, to prevent receiver circuitry 114 from receiving signals using input pad 226 and a second mode, i.e., a receiver mode, to allow receiver circuitry 114 to receive signals using input pad 226.

In the transmit mode of operation, protection circuitry 304 is configured to provide an electrical path for signals received on input pad 226 that provides a significantly lower electrical resistance than an electrical path to receiver circuitry 114. In one embodiment, protection circuitry 304 creates an electrical path between the electrically conductive structure of input pad 226 and ground, i.e., protection circuitry 304 shorts input pad 226 to ground. In another embodiment, protection circuitry 304 creates an electrical path between the electrically conductive structure of input pad 226 and a voltage supply (not shown), i.e., protection circuitry 304 shorts input pad 226 to the voltage supply. In a further embodiment, protection circuitry 304 creates an electrical path between the electrically conductive structure of input pad 226 and the electrically conductive structure of another input pad 226 in another instance of interface unit 300, i.e., protection circuitry 304 shorts input pad 226 to another input pad 226, using a shorting switch (not shown). The shorting switch may, however, cause performance degradation in receiver circuitry 114. In each embodiment, protection circuitry 304 prevents the signals from reaching receiver circuitry 114.

In the receive mode of operation, protection circuitry 304 is configured to ensure that the electrical path in protection circuitry 304 has a significantly higher electrical resistance than the electrical path between filter circuitry 110 and receiver circuitry 114. Accordingly, protection circuitry 304 allows the signals from filter circuitry 110 to reach receiver circuitry 114 using input pad 226.

FIG. 4 is a schematic diagram illustrating one embodiment of interface unit 300. In the embodiment of FIG. 4, buffer circuitry 302 includes first and second inverters 402 and 404 and protection circuitry 304 includes n-channel MOS transistor 412, p-channel MOS transistors 414 and 416, and resistive element 418.

Buffer circuitry 302 receives signal 122 from control circuitry 106 (shown in FIG. 1) at an input of inverter 402. Inverter 402 inverts signal 122 and provides inverted signal 122 to an input of inverter 404. Inverter 404 inverts inverted signal 122 to generate buffered signal 306 and which restores the original logic level of signal 122. Inverter 404 provides buffered signal 306 to the gate of transistor 412. Using invertors 402 and 404, buffer circuitry 302 provides enhanced electrical isolation between input pad 226 and other input pads relative to control circuitry 106, filter circuitry 110, and receiver circuitry 114. By doing so, buffer circuitry 302 allows signal 122 to operate numerous instances of protection circuitry 304 while preventing signals from control circuitry 106, other filter circuitry 110, and other receiver circuitry 114 from affecting the operation of input pad 226.

Protection circuitry 304 receives buffered signal 306 from the output of inverter 404 and causes one of two states of transistor 412 in response to a logic level of buffered signal 306.

In the first state, signal 122 provides a high logic level to the gate of transistor 412 to cause transistor 412 to short input pad 226 to ground. The first state of transistor 412 corresponds to the transmit mode of operation where transistor 412 prevents receiver circuitry 114 from receiving signals using input pad 226. When a high logic level is provided to the gate of transistor 412, transistor 412 creates an electrical path to ground in the channel between the source and the drain of transistor 412 for signals received on input pad 226. In the first state, transistor 412 provides a sufficiently low resistance between the source and the drain to short input pad 226 to ground. Accordingly, protection circuitry 304 prevents signals received on input pad 226, e.g., RF signals from filter circuitry 110, from reaching receiver circuitry 114. In the first state, transistor 412 also provides ESD protection to input pad 226 by providing a path to ground for any transient voltages or signals received on input pad 226.

In the second state, signal 122 provides a low logic level to the gate of transistor 412 to cause transistor 412 to provide ESD protection to input pad 226. The second state of transistor 412 corresponds to the receive mode of operation where transistor 412 allows receiver circuitry 114 to receive signals using input pad 226. When a low logic level is provided to the gate of transistor 412, transistor 412 provides a relatively high resistance between input pad 226 and ground. Accordingly, protection circuitry 304 allows signals received on input pad 226, e.g., RF signals from filter circuitry 110, to reach receiver circuitry 114.

In the second state, transistors 412, 414, and 416 and resistive element 418 provide ESD protection to receiver circuitry 114. In response to relatively a large voltage or current on input pad 226, e.g., from the discharge of static electricity, either the relatively high resistance between input pad 226 and ground across transistor 412 or the relatively high resistance between input pad 226 and the voltage plane, V_{dd}, across transistor 414 is overcome to provide an electrical path to channel the large voltage or current from input pad 226 to ground or the voltage plane. Accordingly, protection circuitry 304 prevents relatively large voltages or currents from causing damage to receiver circuitry 114.

In other embodiments, transistors 412, 414, and 416 may be replaced with other types of transistors.

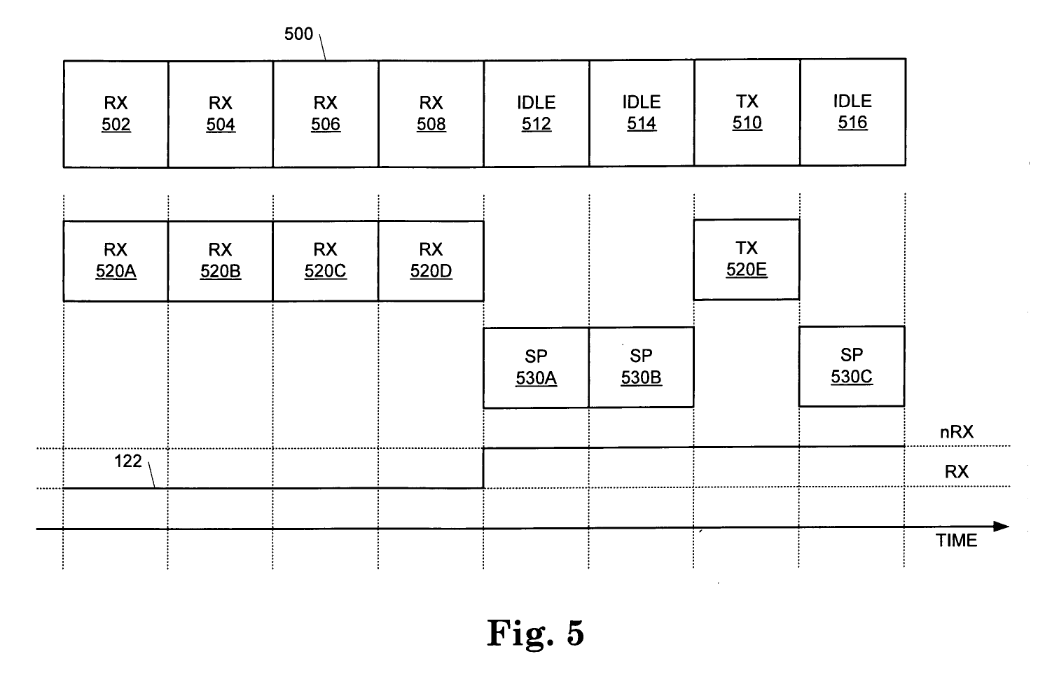

In one embodiment, mobile communications system 100 and mobile communications system 200 implement time-domain isolation according to a GPRS class 12 application as illustrated by the graph of FIG. 5. FIG. 5 shows one example of a GPRS data frame 500 in a typical GPRS class 12 application. Frame 500 includes 8 slots which correspond to bursts of data: four receive slots 502, 504, 506, and 508, one transmit slot 510, and three idle slots 512, 514, and 516. The graph of FIG. 5 will be described with reference to mobile communications system 100 as shown in FIG. 1 to illustrate the operation of interface circuitry 116 in a system that implements time-domain isolation.

The order of the various receive, transmit, and idle slots are shown in FIG. 5 for exemplary purposes. Other orders of receive, transmit and idle slots (with monitoring functions) may occur in the operation of mobile communications system 100 such that the orders are compatible with a TDMA system including any GPRS systems up to GPRS Class 12, and any other future TDMA systems which may defined or used.

RF time slots 520A, 520B, 520C, 520D, and 520E coincide with receive slots 502, 504, 506, 508 and transmit slot 510 of frame 500, respectively, as shown in FIG. 5. Signal processing (SP) time slots 530A, 530B, and 530C coincide with idle slots 512, 514, and 516, respectively. RF circuitry 102 is active during RF time slots 520A-520E and baseband processor circuitry 104 is active during SP time slots 530A, 530B, and 530C. RF circuitry 102 and baseband processor circuitry 104 are activated and deactivated in response to signals from control circuitry 106. Accordingly, control circuitry 106 controls the activation and deactivation of RF circuitry 102 and baseband processor circuitry 104. FIG. 5 also includes timing diagrams illustrating the operation of one or more instances of interface circuitry 116 by control circuitry 106 using one or more of signals 122 with reference to the slots in frame 500.

As shown in FIG. 5, during receive slots 520A, 520B, 520C and 520D, control circuitry 106 deactivates baseband processor circuitry 104 and activates RF circuitry. During these RF time slots 520A, 520B, 520C, 520D, at least one instance of receiver circuitry 114 is configured to receive incoming RF signals with a minimum of interference from baseband processor circuitry 104. Accordingly, control circuitry 106 provides signal 122 at a first logic level, RX, e.g., a low logic level as shown in the example of FIG. 5, to interface circuitry 116 in at least one instance of receiver circuitry 114 to operate interface circuitry 116 in the receive mode of operation. By doing so, control circuitry 106 causes the input pads in interface circuitry 116 to allow RF signals, if present, to be received by receiver circuitry 114.

At the end of receive slot 520D, control circuitry 106 deactivates RF circuitry 102 and activates baseband processor circuitry 104. During SP time slots 530A and 530B, each instance of receiver circuitry 114 is idle and does not receive incoming RF signals. In one embodiment, control circuitry 106 provides signal 122 at a second logic level nRX, e.g., a high logic level as shown in the example of FIG. 5, to interface circuitry 116 in at least one instance of receiver circuitry 114 to operate interface circuitry 116 in the transmit mode of operation. By doing so, control circuitry 106 causes the input pads in interface circuitry 116 to prevent any RF signals or other electrical interference from be received by receiver circuitry 114. In other embodiments, control circuitry 106 provides signal 122 at the first logic level RX to interface circuitry 116 to all instances of receiver circuitry 114 to operate interface circuitry 116 in the receive mode of operation during SP time slots 530A and 530B and other time periods where instances transmitter circuitry 118 are not active.

At the end of SP time slot 530B, control circuitry 106 activates RF circuitry 102 and deactivates baseband processor circuitry 104. During RF time slot 520E, one or more instances of transmitter circuitry 118 are active to generate and transmit RF signals. During RF time slot 520E, each instance of receiver circuitry 114 is idle and does not receive incoming RF signals. Accordingly, control circuitry 106 continues to provide signal 122 at the second logic level, nRX, e.g., the high logic level as shown in the example of FIG. 5, to interface circuitry 116 in at least one instance of receiver circuitry 114 to operate interface circuitry 116 in the transmit mode of operation. By doing so, control circuitry 106 continues to cause the input pads in interface circuitry 116 to prevent any RF signals or other electrical interference from be received by receiver circuitry 114 to cause damage or performance degradation to other circuitry.

At the end of RF time slot 520E, control circuitry 106 deactivates RF circuitry 102 and activates baseband processor circuitry 104. During SP time slot 530C, each instance of receiver circuitry 114 is idle and does not receive incoming RF signals, nRX. In one embodiment, control circuitry 106 continues to provide signal 122 at the second logic level, e.g., the high logic level as shown in the example of FIG. 5, to interface circuitry 116 in at least one instance of receiver circuitry 114 to operate interface circuitry 116 in the transmit mode of operation. By doing so, control circuitry 106 continues to cause the input pads in interface circuitry 116 to prevent any RF signals or other electrical interference from be received by receiver circuitry 114. In other embodiments, control circuitry 106 provides signal 122 at the first logic level RX to interface circuitry 116 to all instances of receiver circuitry 114 to operate interface circuitry 116 in the receive mode of operation during SP time slot 530E and other time periods where instances transmitter circuitry 118 are not active.

In other embodiments, the timing of events may be altered according to any number of criteria, including the hardware utilized in conjunction with mobile communication system 100.

FIG. 6 is a block diagram illustrating one embodiment of a mobile communications device 600 that includes mobile communications system 100 as shown in FIG. 1 or mobile communications system 200 as shown in FIG. 2. Mobile communications device 600 may be any type of portable communications device such as a mobile or cellular telephone, a personal digital assistant (PDA), and an audio and/or video player (e.g., an MP3 or DVD player). Mobile communications device 600 includes mobile communications system 100 or 200, an input/output system 602, and a power supply 604. Mobile communications device 600 may also include a multi-mode cellular system supporting WCDMA in addition to GSM/GPRS, Bluetooth, and/or WLAN.

Input/output system 602 receives information from a user and provides the information to mobile communications system 100 or 200. Input/output system 602 also receives information from mobile communications system 100 or 200 and provides the information to a user. The information may include voice and/or data communications. Input/output system 602 includes any number and types of input and/or output devices to allow a user provide information to and receive information from mobile communications device 600. Examples of input and output devices include a microphone, a speaker, a keypad, a pointing or selecting device, and a display device.

Power supply 604 provides power to mobile communications system 100 or 200, input/output system 602, and antenna 606. Power supply 604 includes any suitable portable or non-portable power supply such as a battery.

Mobile communications system 100 or 200 communicates with one or more base stations 610 or other remotely located hosts in radio frequencies. Mobile communications system 100 or 200 transmits information to one or more base stations 610 or other remotely located hosts in radio frequencies as indicated by a signal 620. Mobile communications system 100 or 200 receives information from a base station 610 in radio frequencies as indicated by a signal 630. In other embodiments, mobile communications system 100 or 200 communicates with base stations 610 using other frequency spectra.

In the above embodiments, a variety of circuit and process technologies and materials may be used to implement communication apparatus according to the invention. Examples of such technologies include metal oxide semiconductor (MOS), p-type MOS (PMOS), n-type MOS (NMOS), complementary MOS (CMOS), silicon-germanium (SiGe), gallium-arsenide (GaAs), silicon-on-insulator (SOI), bipolar junction transistors (BJTs), and a combination of BJTs and CMOS (BiCMOS).

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A system comprising:
first interface circuitry that includes a first input pad of first receiver circuitry; and
control circuitry configured to operate the first interface circuitry in a first mode to prevent the first receiver circuitry from receiving a first signal using the first input pad and a second mode to allow the first receiver circuitry to receive a second signal using the first input pad.

2. The system of claim 1 wherein the control circuitry is configured to operate the first interface circuitry in the second mode to provide electrostatic discharge (ESD) protection associated with the first input pad.

3. The system of claim 1 wherein the control circuitry is configured to operate the first interface circuitry in the first mode to short the first input pad to ground.

4. The system of claim 1 wherein the control circuitry is configured to operate the first interface circuitry in the first mode to prevent interference from affecting the performance of transmitter circuitry.

5. The system of claim 4 wherein the interference is caused by the transmitter circuitry configured to generate a radio frequency (RF) signal.

6. The system of claim 1 wherein the control circuitry is configured to provide a third signal to the first interface circuitry to cause the first interface circuitry to operate in the first mode or in the second mode.

7. The system of claim 1 further comprising:
buffer circuitry configured to provide electrical isolation between the first interface circuitry and the control circuitry.

8. The system of claim 1 wherein the control circuitry is configured to operate the first interface circuitry in the first mode during a first time slot, and wherein the control circuitry is configured to operate the first interface circuitry in the second mode during a second time slot.

9. The system of claim 8 wherein the first time slot includes a transmit time slot, and wherein the second time slot includes a receive time slot.

10. The system of claim 1 further comprising:
second interface circuitry that includes a second input pad of second receiver circuitry; and
wherein the control circuitry is configured to operate the second interface circuitry in the first mode to prevent the second receiver circuitry from receiving a third signal using the second input pad and the second mode to allow the second receiver circuitry to receive a fourth signal using the second input pad.

11. A method performed by a system that includes receiver circuitry, the method comprising:
operating interface circuitry in a first mode to prevent the receiver circuitry from receiving a first signal using the input pad; and
operating the interface circuitry in a second mode to allow the receiver circuitry to receive a second signal using the input pad.

12. The method of claim 11 further comprising:
operating the interface circuitry in the second mode to provide electrostatic discharge (ESD) protection associated with the input pad.

13. The method of claim 11 further comprising:
operating the interface circuitry in the first mode to short the input pad to ground.

14. The method of claim 11 further comprising:
operating the interface circuitry in the first mode to prevent interference from affecting the performance of transmitter circuitry.

15. The method of claim 14 wherein the interference is caused by the transmitter circuitry configured to generate a radio frequency (RF) signal.

16. The method of claim 11 further comprising:
providing a third signal to the interface circuitry to cause the first interface circuitry to operate in the first mode or in the second mode.

17. The method of claim 11 further comprising:
providing electrical isolation between the first interface circuitry and the control circuitry during the second mode.

18. The method of claim 11 further comprising:
operating the interface circuitry in the first mode during a first time slot; and
operating the interface circuitry in the second mode during a second time slot.

19. The method of claim 18 wherein the first time slot includes a transmit time slot, and wherein the second time slot includes a receive time slot.

20. A communications device comprising:
an antenna;
a mobile communications system configured to communicate with a remote host using the antenna and including:
receiver circuitry with interface circuitry that includes an input pad;
transmitter circuitry; and
control circuitry; and
an input/output system configured to communicate with the mobile communications system;
wherein the transmitter circuitry is configured to transmit a first signal using the antenna, wherein the control circuitry is configured to operate the interface circuitry in a first mode to prevent the receiver circuitry from receiving the first signal using the input pad and a second mode to allow the receiver circuitry to receive a second signal from the remote host using the input pad.

21. The communications device of claim 20 wherein the control circuitry is configured to operate the interface circuitry in the second mode to provide electrostatic discharge (ESD) protection associated with the input pad.

22. The communications device of claim 20 wherein the control circuitry is configured to operate the first interface circuitry in the first mode to short the input pad to ground.

23. The communications device of claim 20 wherein the control circuitry is configured to operate the first interface circuitry in the first mode during a first time slot, and wherein the control circuitry is configured to operate the first interface circuitry in the second mode during a second time slot.

24. A system comprising:
means for preventing receiver circuitry from receiving a first signal using an input pad during a first time slot; and
means for allowing the receiver circuitry to receive a second signal using the input pad during a second time slot that is subsequent to the first time slot.

25. The system of claim 24 wherein the means for allowing includes means for providing electrostatic discharge (ESD) protection associated with the input pad.

26. The system of claim 24 wherein the means for preventing includes means for shorting the input pad to ground.
